(19) United States
(12) Patent Application Publication
(10) Pub. No.: US 2017/0103439 A1
(43) Pub. Date: Apr. 13, 2017

(54) Searching Evidence to Recommend Organizations

(71) Applicants: Kurt Robert KOLB, Burnaby (CA); Maziyar HAMDI, Vancouver (CA)

(72) Inventors: Kurt Robert KOLB, Burnaby (CA); Maziyar HAMDI, Vancouver (CA)

(73) Assignee: GASTOWN DATA SCIENCES, Vancouver (CA)

(21) Appl. No.: 14/877,573

(22) Filed: Oct. 7, 2015

(51) Int. Cl. G06Q 30/06; G06F 17/30

(52) U.S. Cl. CPC G06Q 30/0625; G06F 17/30011; G06F 17/30867; G06F 17/3053; G06F 17/30554; G06Q 30/0631; G06Q 30/0641

(57) ABSTRACT

A computer method and system provide can allow for receiving evidence of a vendor's capability and creating database objects by extracting features therefrom and permitting a user to search for a vendor using the evidence. The system can have a database of case studies and organizations. A user may enter their search query and the search engine determines which vendors or evidence document are most relevant.

### BACKGROUND

In the area of Business-to-Business (B2B) relationship building and procurement, it is common for businesses, as a buyer, to search for vendors to provide new services or products. Searching online for a vendor, by keywords or attributes, using a search engine or directory can be an effective way to retrieve thousands of matching vendors. However, inclusion and exclusion very much depend on the vendor being tagged with an attribute or mentioning a keyword in a description, which is detected by the search engine. Moreover, the presence or absence of these tags relies on someone's decision to use them, which leads to many false positive or false negative results. There is no evidentiary weight to the selection or ranking.

For example, thousands of marketing firm websites use the term “social media,” which will be detected by a search engine or used by a directory engine to suggest to users that thousands of firms offer “social media marketing” services. The actual meaning of the term may range from a primary focus in social media, to sub-specialty in social media, to the mere existence of social media account for a firm. Repetitive use of this term on a website might mislead these engines to highly rank some firms as providing this service. The user would have to investigate many of the search results to determine which vendors actually focus on providing the searched services and what evidence there is for quality and relevant services provided.

Case studies are provided by vendors to promote themselves and are offered as examples of their capability to provide a service/product in a certain way to a certain client segment. The situation and results are particular to the case study and are unlikely to be those of prospective clients. Case studies do, however, offer evidence to a prospective client that the vendor has certain capabilities, more so than merely stating capabilities on a website.

However, a buyer searching for a vendor may discover thousands of possible vendor websites, each of which may have dozens of case studies on their website. Thus because case studies are not centralized, a buyer would have to decide on or short-list a set of vendors, then read all of their case studies on their websites, comparatively score cases and then vendors in order to determine which vendors are most relevant to the buyer and sought services/products.

Moreover some case studies or other evidence of vendor capabilities are not located on a vendor website so the user would have to perform further searches in industry magazines, vendor directories, news articles or a generic Internet search. Any discovered evidence would be evaluated and compared across the set of vendors.

### BRIEF SUMMARY

The inventors have appreciated that the process can be improved by providing a server, database, and system for determining which vendors are most suited for a buyer by providing and weighting evidence of the vendor capabilities.

According to one innovative aspect, certain exemplary embodiments provide a computer-implemented method of identifying vendors. The method comprises: providing a database comprising organization data objects and evidence documents, each evidence document associated with an organization data object and comprising text or tags describing real examples of services or products provided by a vendor identified in the associated organization data object; receiving a search query from a user; identifying, using one or more computing devices, from organization data objects in a database, vendors that satisfy the search query to create a set of matching vendors; identifying, from the database, evidence documents associated with the matching vendors; computing a vendor score for each matching vendor, based on a measure of relevance of their associated evidence documents to the search query; and selecting a subset of matching vendors to display to the user based on the vendor scores.

According to another innovative aspect, certain exemplary embodiments provide a computer-implemented method. The method comprises: receiving, by one or more computing devices, an evidence document; using a document model to performing feature extraction on the evidence documents to identify text features; and storing, in a database, the text features as evidence of attribute values of a vendor, wherein at least one of the attribute values is a service provided by the vendor.

According to another innovative aspect, certain exemplary embodiments provide a computer-implemented method. The method comprises: receiving, by one or more computing devices, from a user, a search query for a service or product; retrieving, by the one or more computing devices, from a database, evidence documents that describe provision of the product or service and computing, by one or more computing devices an evidence score for each evidence document based on a measure of relevance of text features of the evidence documents to the search query; and selecting and displaying, by the one or more computing devices, to the user, a subset of the evidence documents based on their evidence scores.

According to another innovative aspect, certain exemplary embodiments provide a computer-implemented method. The method comprises: receiving, by one or more computing devices, an evidence document from a user; performing document modeling, by the one or more computing devices, on the evidence document to determine text features of the document; displaying the text features to the user; receiving, by the one or more computing devices, from the user, corrections to or confirmation of the text features; and storing, by the one or more computing device, the evidence document in a database with the corrected or confirmed text features.

Other embodiments of the above aspects include a computer system having one or more computer processors and a computer-readable storage device having stored thereon instructions, which, when executed by the one or more processors, cause the computer to perform the method.

### BRIEF DESCRIPTION OF THE DRAWINGS

The invention may be exemplified by the following figures, in which like reference numerals refer to similar elements.

FIG. 1 is an illustration of client and server software agents.

FIG. 2 is a flowchart for creating database objects using evidence documents.

FIG. 3 is an illustration of extracting features and assigning them to attributes.

FIG. 4 is an illustration of aggregating multiple evidence documents.

FIG. 5 is an illustration of topic modeling and inference.

FIG. 6 is a flowchart for matching search query to vendor evidence

FIG. 7 is a user-interface for entering search criteria and receiving results.

FIG. 8 is an illustration of matching multiple criteria to several evidence data.

FIG. 9 is an illustration of matching documents comprising multiple parts.

FIG. 10 is a user interface and flowchart for entering and improving evidence documents.

### DETAILED DESCRIPTION

The present system implements a server, database and system for creating data objects using evidence documents and matching search criteria of a buyer to vendors based on evidence of their capabilities. In exemplary embodiments, buyer criteria are received by the server via a user-interface, preferably divided into separate parts using keywords, filters, or drop-down selections. The search may be for an organization looking to purchase satisfying products or services. The search engine may search by evidence or vendor (or both). The search engine may return search results comprising vendors.

It may be appreciated that a database comprising evidence about vendors' capabilities improves the vendor recommendation process by providing centralized repository of evidence and specific examples of how vendors are able to satisfy the buyer's needs. This data could not have been centrally considered by the user without the system's help. This data may be used to search for and/or rank vendors based on evidence supporting the buyer's search criteria.

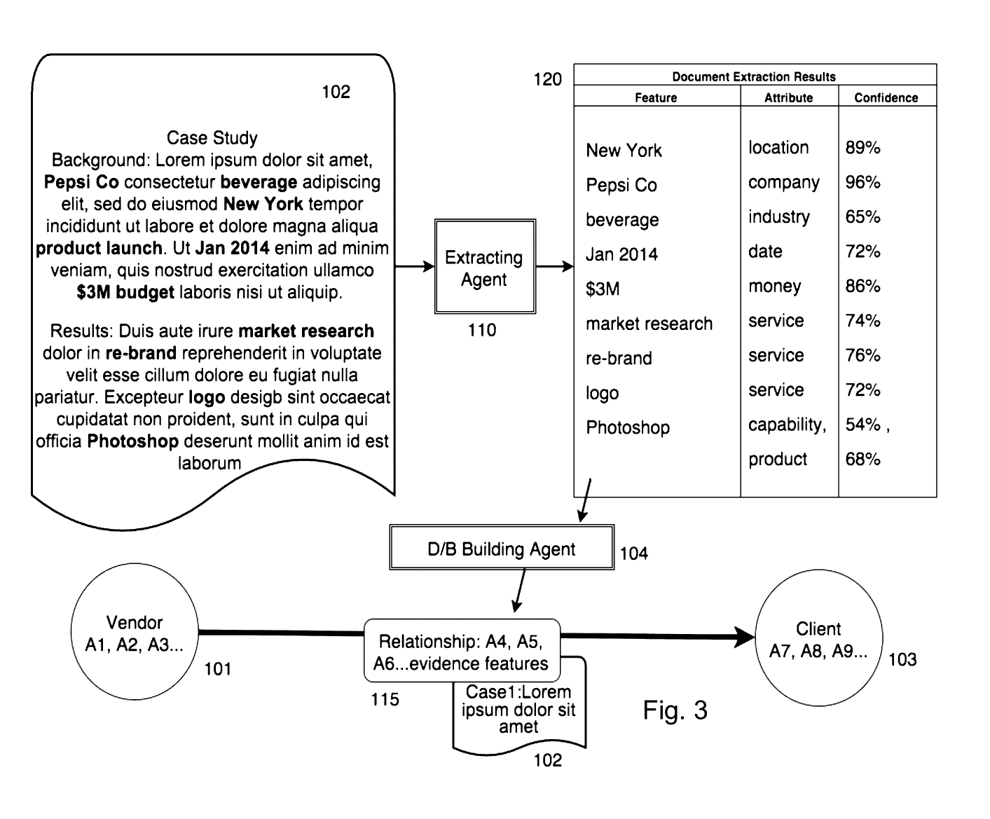

A system, network, business database and computer program are implemented to capture organization attributes, evidence documents, and relationships between organizations. The evidence documents may be a part of the relationship data object or stored separately. The database is structured to connect millions of organizations to each other by business relationships and evidence documents to create a business network. FIG. 3 illustrates an example data structure of a graph storing organization nodes 101,103 connected by relationship edge 115.

The system includes one or more processors for reading instructions from computer-readable storage media and executing the instructions to provide the methods and agents described below. Examples of computer readable media are non-transitory and include disc-based media such as CD-ROMs and DVDs, magnetic media such as hard drives and other forms of magnetic disk storage, semiconductor based media such as flash media, random access memory, and read only memory.

An organization is generally used herein to refer to a legal entity providing or receiving products or services. While an organization may typically be a business, the term includes but is not limited to charities, corporations, sole proprietors, Non-Government Organizations (NGO), institutions, government departments, and partnerships. The term vendor is used herein to refer to organizations that supply products or services in a business relationship, notwithstanding that they may also consume products or services in another relationship. A business relationship is used herein to refer to a business-to-business (B2B) relationship or commercial transactions between organizations to provide those products or services. Preferably the relationship represents a business agreement, which, for example, may subsist in a contract, a terms-of-business document or an ongoing understanding. Most preferably the business relationships stored in the database represent relationships that have been ongoing for at least three months or have at least three repeat instances of transactions. This is in contrast to personal relationships, non-commercial relationships, click-thru data or user website activity data, or one-off commercial transactions.

The organizations may be termed clients (aka consumers, buyers) or vendors (aka suppliers) to indicate their status with respect to a B2B relationship or case study for supply of products for services. Rather than store the client/vendor status with the organization data object, it is preferable to store the status with the relationship or product/service data object because an organization may be a vendor in one relationship and a client in another. As used herein, a buyer is an organization using the present system to find and buy products and services.

An evidence document refers to a real example of how a vendor provided products or services to a client to achieve certain results. The document is evidence of vendor capabilities, such as 1) providing services or products; 2) expertise, qualifications, skills, and specialisms; 3) experience with clients in certain industries and situations, or 4) proficiency with professional tools. Preferably evidence documents comprise text detailing the client industry, the vendor's methodology used, the service provided, product capabilities, and results for the client. Evidence may come from news articles, press releases, case studies, or industry reviews in best practices. Evidence may comprise images, logos, web designs, writing examples, speeches, and other non-text samples of vendor capabilities. In order to process and compare non-text evidence, the system or user adds text or tags, which are stored as the evidence document with the evidence.

A user is generally used herein as a person who interacts with a computer, typically entering evidence or a search query. The user is expected to be associated with a particular organization either seeking information as a potential client (buyer) or providing information as a vendor. Herein the term ‘buyer-user’ is used to refer to a user acting on behalf of a potential buyer and ‘vendor-user’ is used to refer to a user acting on behalf of a vendor. There may be many buyer-users and vendor-users operating the system simultaneously for their own purposes.

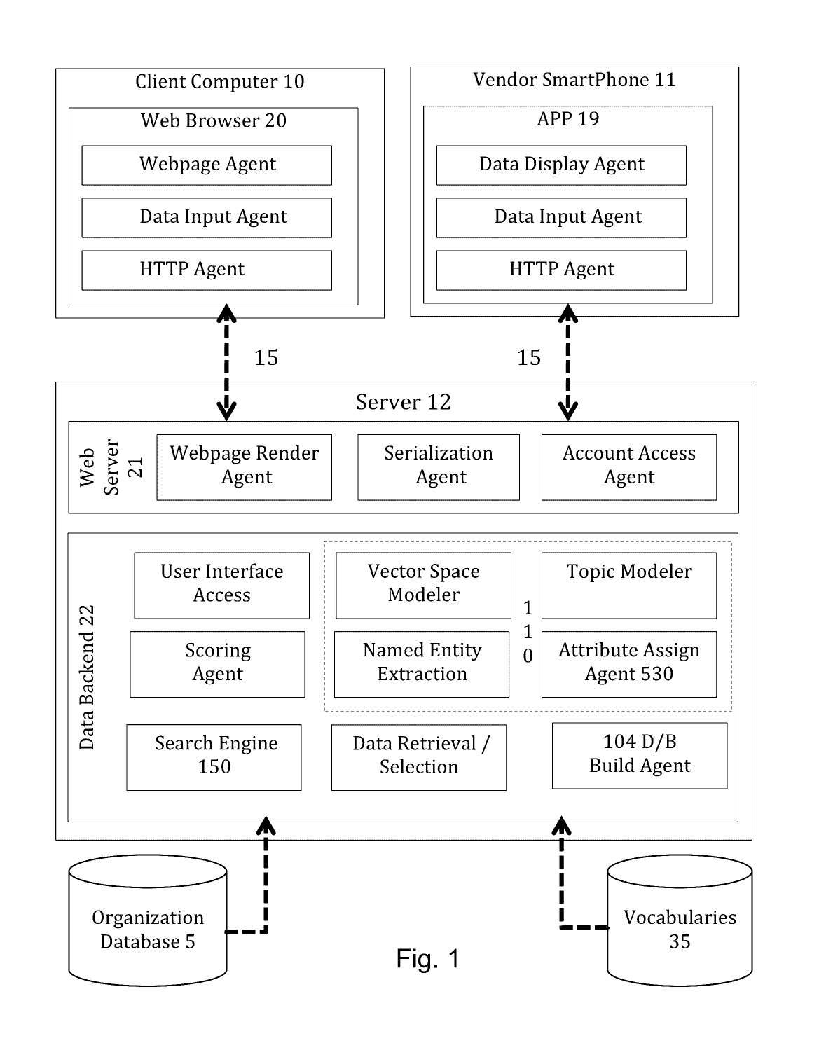

FIG. 1 illustrates the interaction between a client computation device 10 or a vendor Smart Phone 11 and the server 12 over network link 15. The devices 10, 11 may communicate via a web browser 20 or smart APP 19, using software agents to receive input from the user, make HTTP requests and display data. The server 12 may be a reverse proxy server for an internal network, such that the client device 10 communicates with an Nginx web server 21, which relays the client's request to backend processes 22, associated server(s) and database(s) 5, 35. Within the server, software agents retrieve organization identity and case studies, build and interpret the document models, and provide user interface controls. Some software agents may operate within a notional web server to manage user accounts and access, serialize data for output, render webpages, and handle HTTP requests from the devices 10, 11.

Users may access the databases remotely using a desktop or laptop computer, smartphone, tablet, or other client computing device 10 connectable to the server 12 by mobile internet, fixed wireless internet, WiFi, wide area network, broadband, telephone connection, cable modem, fibre optic network or other known and future communication technology using conventional Internet protocols.

The web server will use the serialization agent to convert the raw data into a format requested by the browser. Some or all of the methods for operating the database may reside on the server device. The devices 10,11 may have software loaded for running within the client operating system, which software is programmed to implement some of the methods. The software may be downloaded from a server associate with the provider of the database or from a third party server. Thus the implementation of the client device interface may take many forms known to those in the art. Alternatively the client device simply needs a web browser and the web server 12 may use the output data to create a formatted web page for display on the client device. The devices and server may communicate via HTTP requests.

The methods and database discussed herein may be provided on a variety of computer system and are not inherently related to a particular computer apparatus, particular programming language, or particular database structure. The system is capable of storing data remotely from a user, processing data and providing access to a user across a network. The server may be implemented on a stand-alone computer, mainframe, distributed network or a cloud network.

### Database Format

The data is stored on a memory device comprising a data structure. The data structure may be implemented in a variety of ways known within computing science, such as an object database, relational database or a graph database. As used herein a collection of data about an organization/relationship/case study is called a data object, without limitation to a specific data schema. As this method is implemented in a computing environment, references herein to operations with organizations, relationship, and case studies are to the related data object.

The structure may be with first data objects representing organizations and recording attributes of the organizations and second data objects connecting two first data objects to record a business relationship between them.

The structure also has evidence data objects recording the capabilities of organizations to supply services. The evidence data objects may record features of evidence documents, the evidence document itself, and evidence metrics for the features. The evidence data objects may be a table stored with or connected to a first data object aggregating evidence of an organization to supply services. Alternatively the evidence data objects may be a table stored with or connected to a second data object and may store features, attribute types and tags of the evidence document, and also the document itself.

The bottom of FIG. 3 illustrates an example data structure of a graph whereby organizations 103, 101 are stored as nodes and relationship edges 115 connect the vendor organizations 101 to their client organizations 103. The relationship edge may store evidence, such as a case study 102. Each of the data objects 101, 102, 103 can include a plurality of attributes A1, A2 . . . An to record data such as location, size, age, industry, services, products, brands, and revenue.

The system stores data for organizations in the database and can find or compare organizations depending on the nature of the data. The organization data may be conceptually divided into different categories:

Identification data that enable the system to identify the organization. Identification data includes data such as legal name, parent company name, CEO's name, office address, IP address, logos, brand names, or company registration number;

Profile information about the organization history, expertise, and accomplishments, possibly in an unstructured text format;

Attribute data that describe properties of the organization using categories or values, but do not identify the organization. Attribute types comprise industry, sector, general location, specialization, product category, service category, number of employees, market capitalization, field of practice, or revenue; and

Business segment data, as a subset of attribute data, for describing the business function or division of an organization that includes attribute types such as industry, sector, specialization, product class, service class, or field of practice.

### Importing Evidence to a Database

Evidence documents, such as case studies, may be used to build up the database 5 and learn attributes of organizations and their relationships. The extracted features should include features about a) client identity or industry and also b) service or product provided in order to provide the most relevant signal to the user. The features also include one or more of: location data, methodology, tools/skills used in the service, result of the service or product, or client situation, in order to better convey details of the evidence.

In one embodiment the system extracts information from evidence documents using information retrieval techniques, such as topic modeling and vector space modeling.

The server comprises an extracting agent that performs feature extraction to identify text (words, phrases and n-grams), and categorizes the features into attribute types. This agent may employ tools such as Named-Entity Recognition, from libraries such as GATE, NETagger, OpenNLP, Alchemy API (from IBM), and Stanford CoreNLP to identify entities such as locations, companies, people, and quantities from the document text. The agent may use the context of the features, capitalization, grammar, sentiment and. This enables the system to distinguish whether an entity is “at”, “near”, “to” or “in” a location. For example, in the sentence, “Company B, in location1, provides service to location2,” the prepositions indicate how to categorize the location features.

Semantic relations between features help determine which entity performed a service for another entity. For example, in comparing the sentences “Company A helped Company B” to “Company B was helped by Company A” the agent must distinguish between active and passive verb constructions to determine that Company A is the vendor.

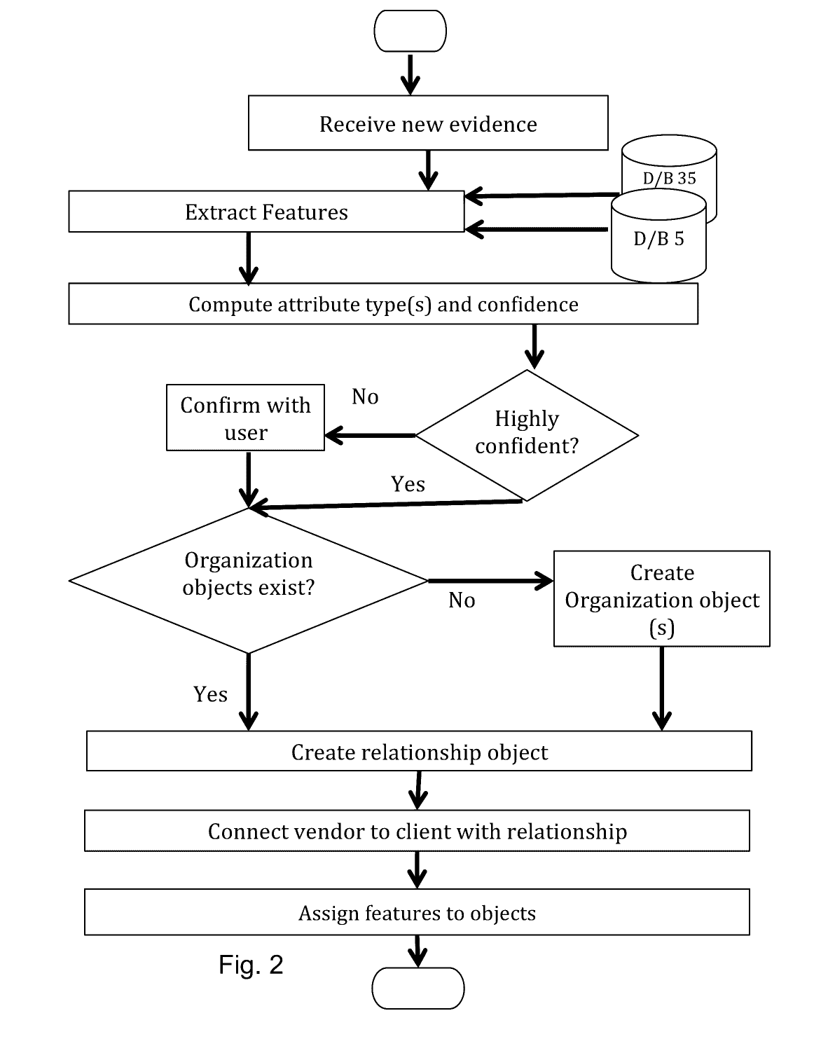

In FIGS. 2 and 3, the extraction agent 110 receives a document 102 and then identifies features matching terms in a vocabulary 35 stored in a database. The vocabulary also indicates the attribute type of the matching features in order to categorize the feature and calculate a confidence of that categorization. Ideally the extraction agent identifies and distinguishes vendor, client, and service features to create organization objects 101,103 and relationships 115 therebetween. Features that cannot be assigned to an organization or relationship can nonetheless be stored in the document's evidence table 120 for subsequent search. If the organization objects do not exist in the database 5 then a database-building agent 104 creates new organization objects. If the organization objects exist then the extracted features can be compared with the existing attribute values (location, industry, etc.) to confirm that a feature is a likely description of the organization or that the correct organization object has been identified in the database.

The database-building agent assigns the extracted features to attributes of the data objects based on their categorized attribute type. The extracted features may be stored as values of attributes for a data object, which requires a high confidence that the feature is correctly identified and categorized. The agent may store the feature as evidence of an attribute value, rather than as the attribute value itself. The evidence may relate to vendor capabilities, such as services provided, products provided, tools used, specialties, locations served, channels used, and industries served.

Continuing with FIGS. 2 and 3, the database-building agent 104 may create a relationship data object, if one does not exist, connected to the client and vendor data objects. This relationship object comprises a data element recording the direction of products/services from a first organization (vendor) to a second organization (client), and may comprise attribute data such as the type of product or service provided, dates or duration of the relationship, and evidence table 120 of features extracted from the evidence document. The relationship may also stores or points to the evidence document 102.

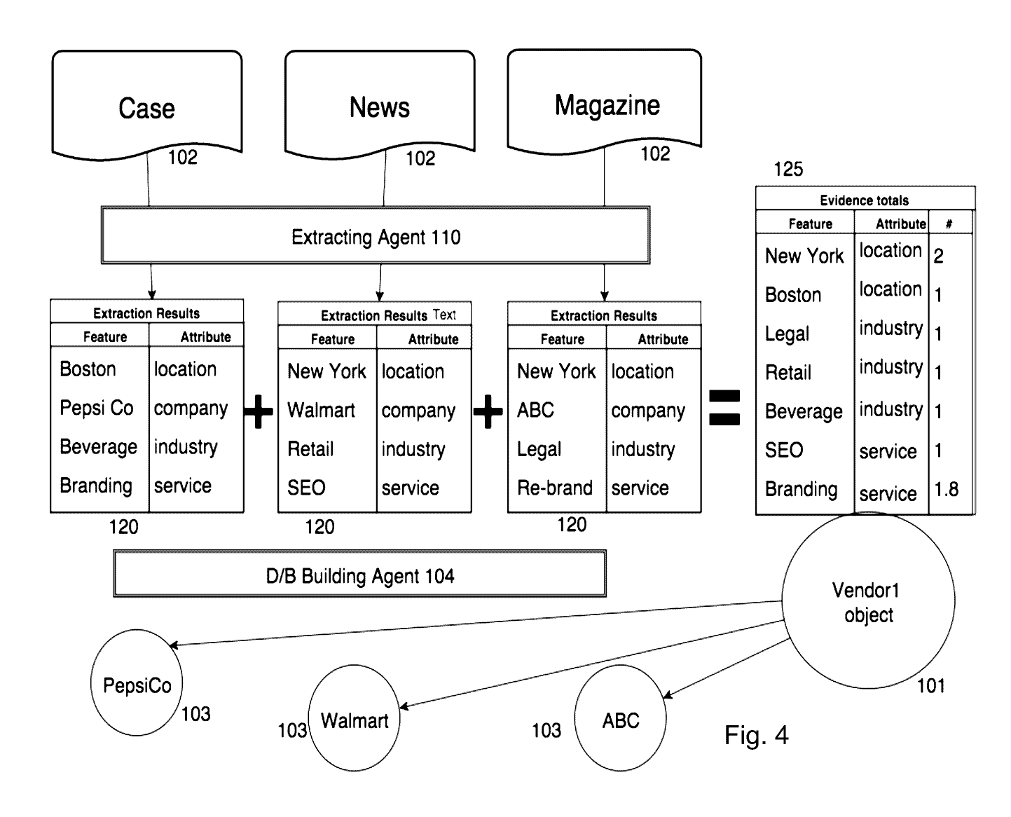

A table of aggregated evidence is shown in FIG. 4. The totals for each evidence attribute may be a tally of evidence documents that contain a relevant feature or a sum of extracted features, weighted by the confidence and relevance. Thus the system considers vendors to have good evidence of a capability if the data source is reliable, the context of the feature is clear, the sentiment is positive for that capability, and the feature is highly correlated with that capability.

In FIG. 4, the extracting agent extracts features from three (potentially hundreds of) documents of Vendor1, categorizing features into attribute types (e.g. location of service, client name, client industry, and service performed). The database building agent sums the weighted evidence 120 to create an evidence table 125 in the database, which is associated with or comprised in Vendor1's data object. In this example, the client names are used to link to client data objects (not shown), rather than used in the table. The client industry and location are added to the table as evidence of the vendor's capability to serve these. Branding and re-branding are combined as evidence of branding, albeit with re-branding only 80% correlated with the service, ‘branding,’ in this example.

Identifying features or topic headers from a document using information retrieval (IR) techniques can be accompanied by a confidence, frequency or probability measure of those features. This helps the system distinguish between words that merely appear once, ambiguously and those that are used repeatedly with unambiguous semantics. A further consideration is the confidence that the features are assigned to the correct attributes types and correct object. For example, “Washington” might refer to a location, government, university, person or company. IR techniques such as NER attempt to disambiguate this from the surrounding context to assign attribute types and calculate confidence measures. The attribute type and confidence can be improved by comparing the features to sets of vocabularies 35 for known locations, company names, and categories of services and products. This helps the extraction agent determine that a feature is a known term within the assigned attribute type and also the number of similar features with which it may be confused. The extraction agent may further compare the feature and attribute type with the known attribute values of organizations involved in the relationship from database 5. Thus, if the feature “Washington” is likely to refer to a company and the vendor entering the case study is called “Washington LLP” located in Florida, then the extraction agent increases the likelihood that the attribute type is a company AND that the feature should be assigned to the vendor data object.

The extraction agent can compare the confidence/probability measure to threshold values to determine whether and where to assign the feature, e.g. the thresholds for setting, replacing or merely corroborating attributes may be different. In cases where the confidence is too low, the extraction agent may provide, via the UI, a way for the user to confirm features, the proposed attribute types and proposed data object. For example, the ambiguous feature “Washington” may be displayed to the user as a possible vendor location attribute, client location attribute, or client name. In the absence of user-confirmation, these features may be assigned as keywords of the evidence document and stored with the evidence or relationship data object.

Importing evidence documents and extracting their features into the database enables the subsequent process of searching for vendors, scoring them, and displaying evidence for them.

### Document Modeling

Alternatives to named entity extraction, as discussed above, include topic modeling (such as Latent Dirichlet Allocation (LDA, LLDA, pLDA), Non-Negative Matrix Factorization (NMF)) or vector space modeling, such as semantic similarity or term similarity. These techniques do not consider word order, grammar or semantics so it is preferable to include other processing steps to assign features to attribute types, using vocabularies 35 and existing data in organization database 5, as discussed above.

The vector space model represents a document as a vector of features (words or n-grams) whilst a topic model represents a document as a probability of discussing certain topics. Both models may include pre-processing steps to filter out stop words, seed the model with known keywords and/or reduce the number of features using principle component analysis (PCA) or latent semantic analysis (LSA). Thus the model will not include common words (e.g. “and”, “if”, “the”), will include desirable keywords (e.g. marketing, legal, consulting), and will merge very similar words or synonyms into the same feature (e.g. advertising=adverts, ads, ad words, commercials). The model agent may use Term Frequency-Inverse Document Frequency (TFIDF) to weight the features.

As an example, Topic Modeling, using LDA, is performed on a collection of evidence documents to discover a set of topics to describe the documents in the collection. A topic is defined as a distribution over many words or n-grams. A document is a collection of words and can be expressed as a probability of topics. The topics may have the effect of creating clusters of document, whereby each document in a cluster have a high probability of discussing that topic.

In exemplary embodiments, the clusters or classes are related to capabilities of vendors and/or types of clients, such that the documents within a class or cluster are evidence of a certain capability or serving a type of client. For example, a cluster may comprise documents united by the features: “semiconductor”, “photolithography”, “wafer dicer”, “clean room”, “40 nm”, and “foundry”, whereby the cluster effectively describes ‘provision of factory equipment’ and ‘semiconductor clients.’ Clusters or topics that are deemed to be irrelevant to searching for evidence may be deleted by the system or system administrator.

The topics and documents are not formally identified by a keyword, unless LLDA is used, whereby topics are labeled by an administrator. Topic features may be displayed to the user, referring to the most frequently used words for a topic, ignoring stop words.

Term Frequency Inverse Document Frequency (TFIDF) is another method to discover and weight important, informative keywords in a collection of documents, by determining features that are frequently used in a document but infrequently used in the collection overall. These features may be shown to the user as a concise representation of a document or collection of documents that describe a common capability.

An advantage of topic modeling and semantic relatedness techniques is that documents can be identified from a search query even though an exactly matching word is not used in the document. Clusters of documents with a common topic will, on aggregate, have similar distributions over the words. Also the modeling does not require supervised learning.

There is no hard ratio between the number of topics and documents. Typically, the number of topics (k) increases sub-linearly with number of documents (n) e.g., N_topics=square root of M_documents. In the present system, the number of topics may be on the order of the number of capabilities that the system is intended to model for vendors in the database. For example, a system providing a recommendation of Marketing and Advertising firms offering about 20 specialties (SEO, brand identity, content marketing, etc.), each of which may be handled in ten ways (taking into account industrial niches and different vendor tactics) would need to cluster the case studies into about 200 topics. Having many more topics would mean some topics would be highly correlated or modeling noise. Having many less topics would mean confounding different case studies. The database should therefore comprise at least O(10⁴) evidence documents (e.g. 40,000) in order to train the model.

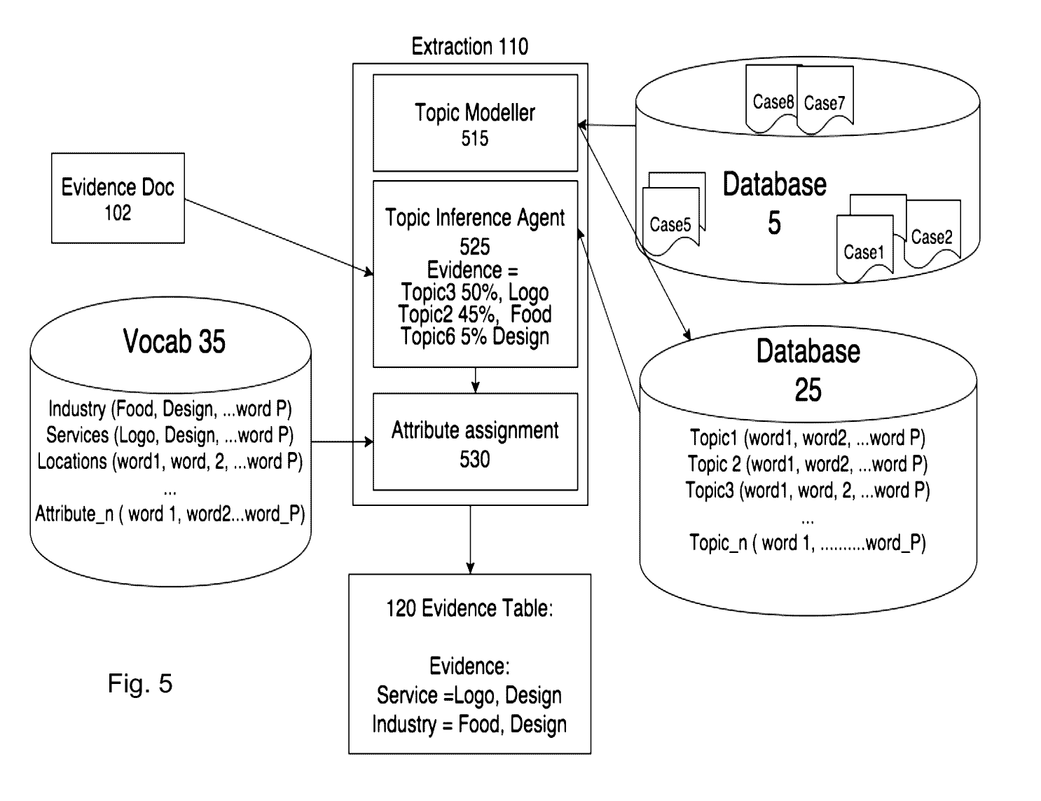

FIG. 5 shows a block diagram showing the interactions between the organization database 5, topic model 25, vocabulary sets 35, the extraction agent 110 and evidence document 102, and evidence table 120. In this example, thousands of documents in database 5 are reduced to N topics, each described by P words, and stored in database 25. The topic inference agent determines that evidence document 102 likely discusses Topic 3 and 2, with Topic 6 shown but improbable. These topics are represented here by the simplified features of “logo”, “food”, and “design”, respectfully. When looked up within vocabulary database 35, the attribute assignment agent 530, determines that the document is evidence of certain services and client industries. These results are stored in the evidence table 120 with confidence metrics (not shown).

### Data Source

The system's data input agent provides one or more ways to input an evidence documents to the database. The agent may provide a website data entry form, capability for uploading a data file, an API callable by third-party software, or a web crawler. The document may be input by a user working on behalf of one of the organizations in the relevant relationship and comprises details about the relationship and the other organization. In one embodiment, a web crawler scours the webpages of vendor organizations, trade journals, and/or news websites to find evidence of services/products provided to a client. Case studies may be stored on one or more databases within the present system but they could be stored on remote databases, such as storage devices operated by vendors, in which case a modeled representation of the case study is stored locally including the location of the remote storage.

In exemplary embodiments, a user inputs the document into a user-interface provided by the web server. A document comprises text, preferably comprising at least 100 words, more preferably at least 250 words. Common words and highly unusual words are unhelpful to some machine models but are useful to both author and human readers. While the system does not control the user's authorship of the document, a document building agent via the UI may encourage the user to input a useful document by asking for more words or suggesting descriptive words. The greater the number of words and more topic-specific they are, the more effective the extraction agent will be.

Where the evidence comprises a non-text work sample such as a logo, design, web page layout, graphic, video, or radio ad, the document-building agent prompts the user to add some text description to create the evidence document. The document-building agent may use machine techniques such as image processing, optical character recognition, and speech recognition to automatically determine keywords relevant to the work sample. For example, a vendor-user may submit a JPEG of a magazine ad for a car with the client logo and a description of the car. The extraction agent 110 examines the image for text using optical character recognition, logos using image matching tools, and objects using image recognition. These are displayed to the user for selection/deletion.

### Document Improvement

In exemplary embodiments, the document-building agent helps vendor-users enter the evidence document, to create a compelling case study, using machine learning. This agent may help the user enter their documents into the appropriate parts, such as situation, industry, problem, services/products provided, methodology and results. The agent identifies and displays text features extracted from the new document and their assigned attribute types to the user via the UI, receives correction or confirmation from the user and then stores the confirmed or corrected text features or attribute types in the database with the new evidence document.

For example, as shown in FIG. 5, the agent may use the topic model to infer the most probable topics discussed in a new evidence document. Topic headers from a plurality of the most probable topics are shown to the vendor-user. Similarly, in FIG. 2, extracted features and their assigned attribute types may be displayed to vendor-users for confirmation.

If the vendor-user does not agree that the evidence document is described by the topic suggestions, extracted features or attribute types, then the agent displays more topics, features or attribute types from the document or even all the classes and attribute types in the system. The document-building agent may prompt the user to explicitly enter keywords with which the evidence document should be tagged or classified. The agent determines which common features are frequently used for the selected topic(s) but are not in the vendor's case study document, and displays these words. The agent may also display example evidence documents within the selected topic.

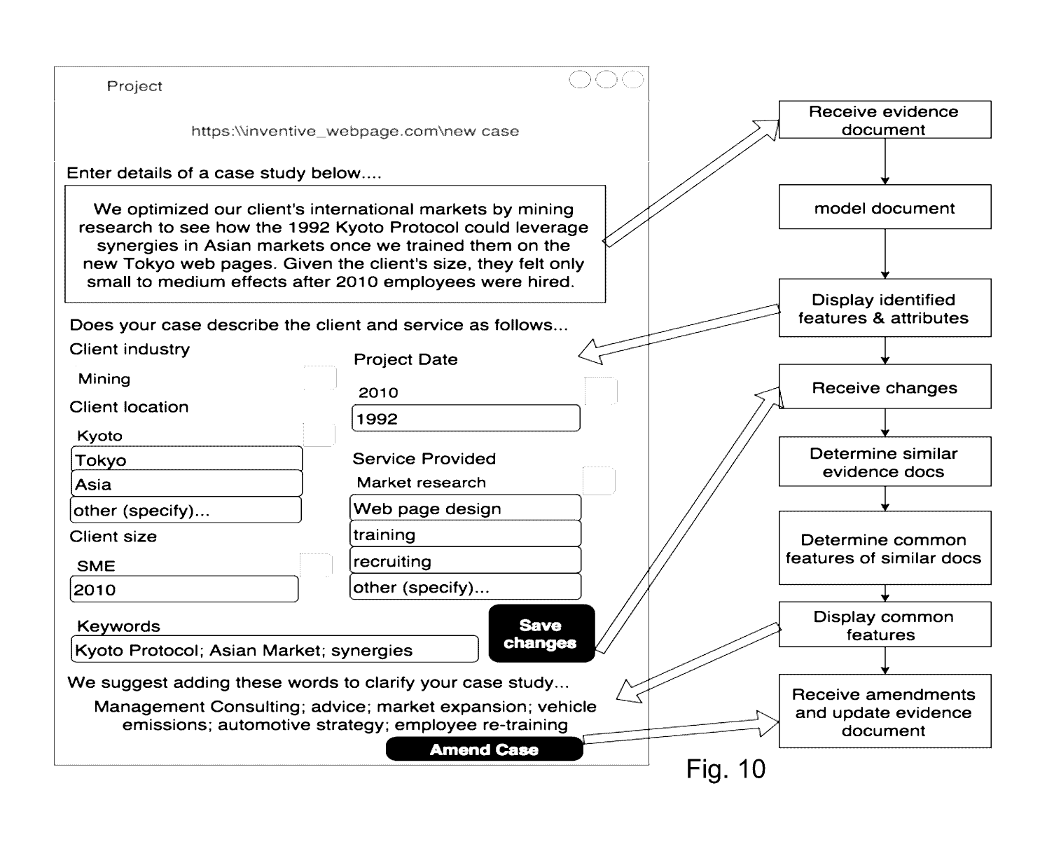

FIG. 10 shows a case study entered by a vendor that is not easily modeled for keywords or assigned to the correct attributes. The vendor-user is shown the initial efforts from the model (which are all wrong here) and is able to correct the model. The document building agent uses the corrections to add new features, remove features, or re-assign attribute types to features. Thus if the user corrects the client/service features, re-assigns attributes, and add keywords to indicate that the case was really about providing “management consulting” services for an “automotive” client in relation to the “Kyoto Protocol,” the agent would update the features and attribute types of the evidence document and store these in the database. The document building agent may also determine, from the corrections, a set of similar evidence documents in the database, and from those documents determine a set of words/phrases used therein and not used in the new case study. The agent retrieves other evidence documents and calculates similarity of the other evidence documents to the new evidence document based on their respective text features. The agent selects one or more of the other evidence documents based on the calculated similarity and displays the selected documents or some of their text features to the user.

In the example, a set of automotive consulting documents is identified and commonly used words used therein are suggested to the user. The commonly used words may be determined using feature extraction techniques as discussed herein, such as topic modeling, vector space modeling, NER, and TFIDF. The user may then amend their case study text and save the document to the database. Advantageously the new and amended case is more likely to be discovered and deemed relevant by a buyer-user.

The case study building agent may also function offline, sending suggestions to a user for improvement from time to time. The agent may communicate to a vendor that their case study terminology is unconvincing to buyer-users or wrongly modeled by the system using the current words.

In addition to the attribute types and features for which there is evidence in the document, the system may enable the user to tag the document. These tags may more accurately identify the document or emphasize the keywords that the vendor-user wants to convey. Advantageously, this prompts the vendor-user to define their evidence or their organization in useful terms they did not enter into the free-text box. For example the UI may ask questions of the user about the case study or client involved. Some of these questions may refer to attributes such as size, location, industry, customer markets, services/products and specialties.

These may be tags about the case and/or organization involved. The organization database 5 may have data about the client or vendor attributes, which may be used if organizations are identified. However, the user may want to tag an organization with different attributes than stored in the database to emphasize something. For example, a client may work in many industries but, for the present case study, only one industry is relevant.

In one embodiment, the document building agent parses the text for words or n-grams that are compatible with each attribute type, e.g. cities are compatible with location tags, names are compatible with client tags, numbers are compatible with financial tags, etc. Alternatively the agent may determine which of the extracted keywords are compatible with each attribute type. For each tag category, the system may comprise a vocabulary 35 or model against which, the actual words or modeled keywords in the document are matched. Tools such as Named-Entity Recognition, from libraries such as GATE, NETagger, OpenNLP, Alchemy API (from IBM), and Stanford CoreNLP may be used to identify entities such as locations, companies, people, and quantities from the document text. For example, a word may be identified as a city by a tool, such as Geocoder, which the agent then suggests as a value for the location attribute.

The agent may also use tags (or labels) given to topic(s) that the document is likely discussion. For example, in LLDA an administrator labels the few hundred topic clusters (instead of the many thousand documents), the topic inference agent assigns to a new document one or more topics and the document building agent uses these topic's labels as tags for the new document. The user interface may permit the user to select/deselect tags.

### Vendor Search by Case

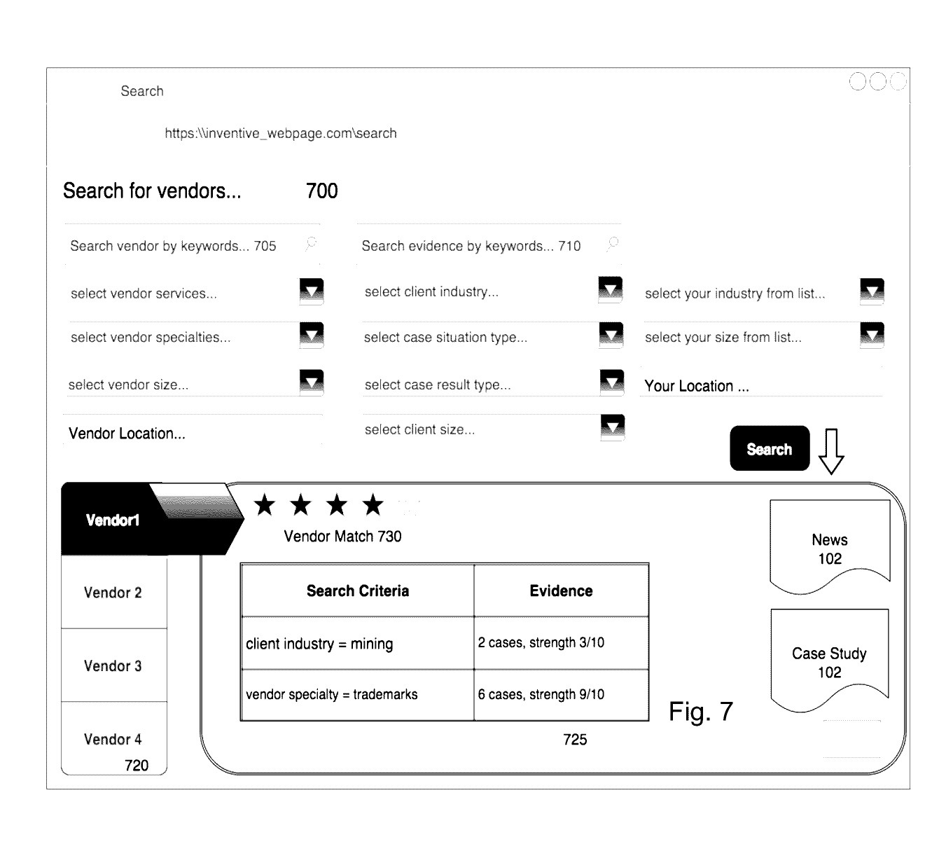

The present search engine enables users to compare vendors based on evidence of their capabilities and relevance to the search criteria. FIG. 7 exemplifies a User Interface (UI) provided to a user to receive a query and display results. The query may comprise multiple search criteria, at least one of which is a service or product to be provided by a vendor. The search engine identifies, from a database of organization, vendors and evidence documents that satisfy the query.

The search engine determines that a vendor or evidence document satisfies a search query based on an exact match of terms, similarity of terms (e.g. synonyms), or a similarity modeling technique (e.g. using vector space modeling or topic modeling).

In one embodiment, the search engine uses the query to identify vendors and reuses at least one search criterion to identify or score evidence from the identified vendors. Thus vendors that have attribute data that satisfy the search criteria and evidence supporting that data will be displayed before or instead of vendors that satisfy the search but without supporting evidence.

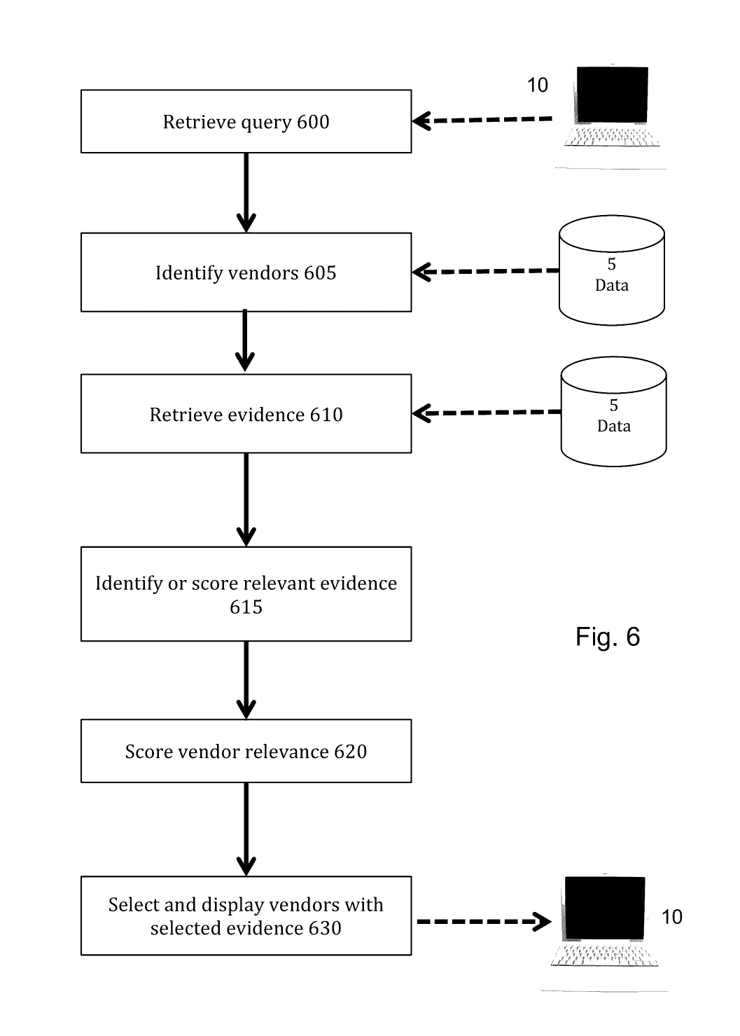

In the flowchart of FIG. 6, the server receives search criteria 600 from a user computer 10 to display a set of vendors. The search engine retrieves vendor data objects 101 from the database 5 that satisfy the criteria to identify a set of matching vendors in step 605. The search engine may be programmed such that some criteria are absolute requirements and some merely affect scoring. In step 610, the search engine retrieves case study document data objects associated with each matching vendor. The search engine determines the extent to which each document is relevant to the search criteria, in step 615. This determination may be made by matching search criteria to features extracted from the document or tags given to the document. In exemplary embodiments, both search criteria and features are assigned to the same attribute type. The search engine may score the document relevance based on the strength of the match (for example, based on similarity and frequency), weight of the search criteria, and where, in the document data object, the match was found (text, tag or topic header).

For identified vendor (in step 605), the search engine sums their associated evidence document scores to compute a vendor score 620. In step 630, the system selects and displays vendors (e.g. by identity, logo or hyperlink) at least partly based on the vendors' scores. Thus the search engine can recommend vendors that satisfy the search and have evidence to back up their claims.

The number of vendors in the subset may be determined from the number of vendors to be displayed on the user's computing device. The order of the displayed vendors may be random or based on the relative score of the vendors (i.e. rank). For example, on a device capable of displaying ten vendors, the search engine selects for the subset, the ten highest scoring vendors. Responsive to a user-request for more vendors, the engine selects a subset of the next ten highest scoring vendors and displays them.

Alternatively or in addition, the search engine selects the subset of vendors by selecting, for each search criterion, at least one vendor that has the most evidence for that search criterion. Thus a vendor may be selected by having many evidence documents that are evidence of a particular criterion indicating they are specialist with respect to that criterion.

Alternatively or in addition, the search engine selects the subset of vendors by selecting, for each search criterion, at least one vendor having the evidence document that best satisfies the search criterion.

The vendors to be displayed may be selected according to more than one of the selection rules discussed above.

### Orthogonal Evidence Search

In one embodiment the UI enables the user to enter vendor search criteria for selecting vendors using vendor attributes and evidence search criteria for selecting vendors using their evidence document. Vendor criteria may comprise a service to be provided and optionally one or more attribute values of the vendor (e.g. location). The vendor search identifies vendors that can provide a service whilst the evidence search separately identifies examples of work that is relevant to the user.

This approach allows a buyer-user to search orthogonally for a vendor and their documents. For example, a user could search for a marketing firm providing a skill and located in a particular city and also associated with a case study discussing a particular audience and result.

In exemplary embodiments, the evidence engine identifies case studies that satisfy both the evidence criteria and are relevant to the sought service. Thus the user will see case studies about provision of relevant services in a relevant way. The identified case studies do not need to satisfy other vendor criteria, such as location or size.

### Scoring and Selecting

Generally the Search Engine calculates scores the match between features in evidence documents and the criteria. However as seen from the above scoring techniques, various algorithms may be implemented depending on the goal of the programmer or user. The skilled software programmer will appreciate that many algorithms may be used to calculate vendor and evidence scores within the scope and spirit of the invention. For example, weights may be varied, criteria may be applied as AND or OR operators, and the order of operations for weighting and summing evidence may be changed.

A set of vendors having the highest vendor scores is displayed to the buyer-user. The set may comprise vendors that are highly matched to one criteria of the buyer or are on aggregate have good evidence relevant to the buyer's overall search query. The display may indicate the degree and particular aspects that are a match.

The following is an example of a suitable algorithm. The Engine sums the evidence scores for a single vendor, taking their documents one at a time, for one criterion at a time, to calculate an overall vendor score. The engine ignores evidence scores below a threshold value, so that many bad matches do not contribute towards a high vendor score.

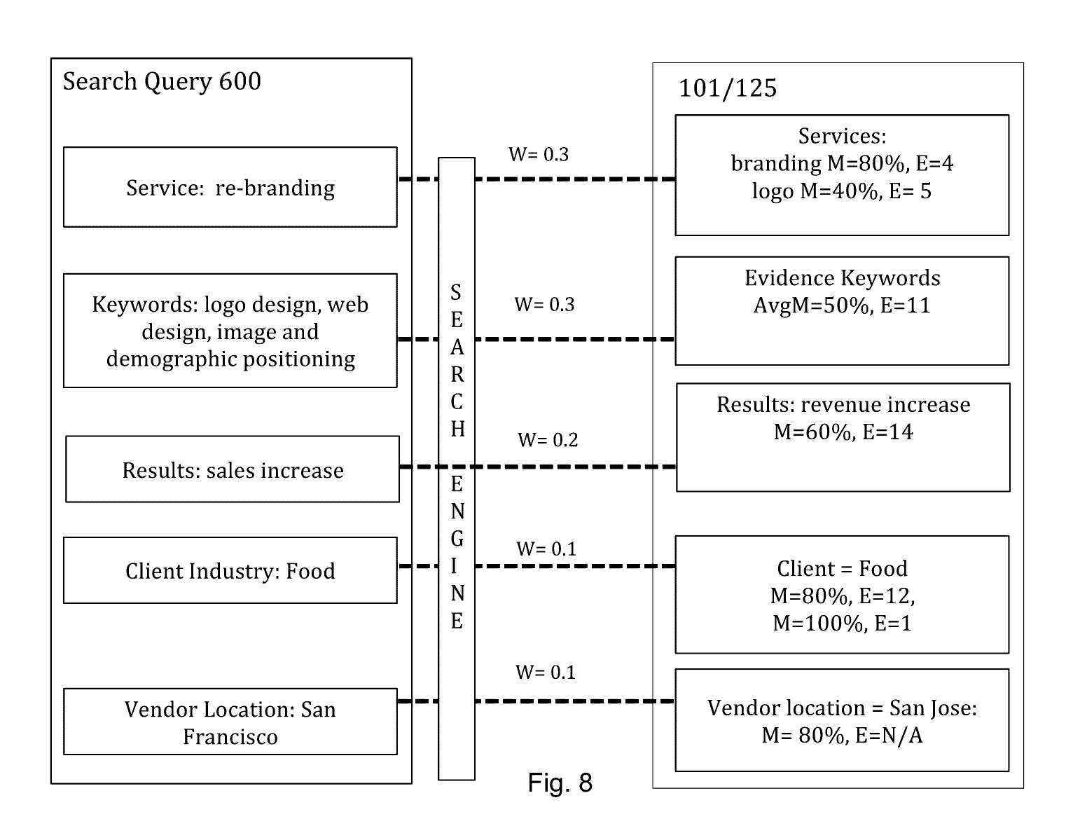

FIG. 8 illustrates a search engine comparing criteria of query 600 to evidence table 125 and vendor attributes 101. Five criteria are satisfied to varying degrees by the attributes and evidence of this vendor. Each criterion is given a weight, W. The degree to which attributes or evidence satisfies the criterion is given a matching score, M. The amount (preferably the weighted amount) of evidence is given an evidence score, E. In this example, there were four documents providing evidence of “branding,” which is 80% matched to the search for “re-branding” services, and five documents supporting “logo” which is a 40% match. The individual evidence scores are multiplied by their matching scores (5×0.4; 4×0.8), summed together (2+3.2), then multiplied by the weight for the criterion (0.3×5.2), and finally summed for all criteria to get a vendor score.

A pseudo code example of implementing a vendor-scoring algorithm is shown below.

//Search all vendors in D/B or limit to vendors that match some critical criteria

| | |
|---|---|
| 1: | For each vendor V_k (k = 1, 2, . . . , K) |
| 2: | evidence_score = 0 |
| 3: | For each criterion c_i (i = 1, 2, . . . , C) |
| 4: | count = 0 |
| | //find all tables of evidence documents associated in the database with |
| | the current vendor; returns a list of doc_tables |
| 5: | doc_tables = Get_doc_tables (V_k) |
| 6: | For each doc_table d_j in doc_tables |
| | //find nearest feature in document table to the criteria and return a |
| | match score from zero to one |
| 7: | count = count + match(d_j, c_i) |
| 8: | Next doc_table (increment j, go to line 7) |
| 9: | evidence_score = weight(i) × In(count +1) + evidence_score |
| 10: | Next criterion (increment i, go to line 4) |
| 11: | vendor_score(V_k)= evidence |
| 12: | Next vendor (increment k, go to line 2) |

The evidence to be scored may be narrowed to those a) documents from vendors that must satisfying certain of the criteria and/or b) documents must satisfying certain of the criteria. Thus instead of scoring or searching within a million candidate documents, the system need only consider hundreds. The evidence may be counted and weighted using the vendor evidence table 125, document extraction tables 120, or the documents 102 directly, in order of decreasing access speed for the Search Engine. For example, for unusual keywords the Engine may need to search the raw documents, as the keyword is unlikely to be found in the extracted features. However, this potentially requires searching every document. Evidence might not be required for all criteria; the algorithm may treat the evidence weight as 100% or not use any evidence weight for certain attributes. For example, here vendor location is taken as a fact (Evidence=not applicable), with a low weight (0.1) and good match (80%).

The matching score between a feature and a criterion may be binary or a continuous value based on a fuzzy matching or distance algorithm. The system may store correlations between features in a matrix or calculate distance between vector representations of features. Some attributes may be compared by their numerical distance such as city co-ordinates, monetary amounts, or employee counts.

### Multiple Matching

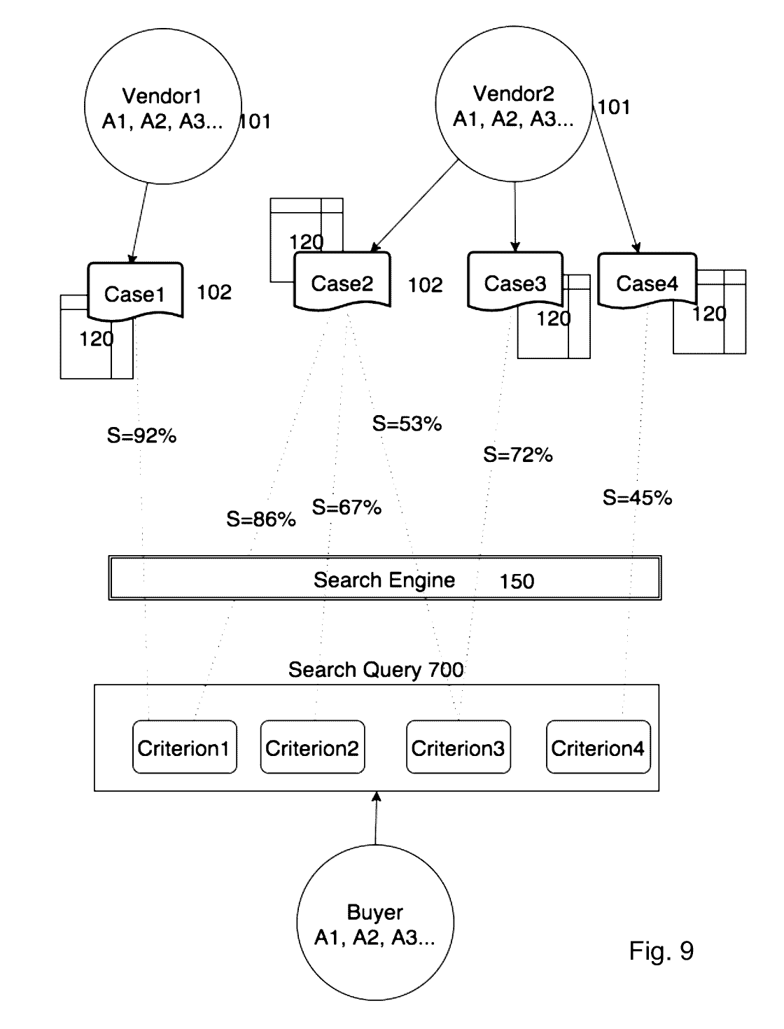

In an alternative embodiment, the Search Engine simultaneously considers a plurality of criteria when scoring evidence documents. This allows the Search Engine to identify evidence satisfying multiple criteria and ignore evidence documents that may be highly relevant for one criterion but irrelevant overall. The search engine can thus be a search for the best evidence of the sought criteria in one document. In FIG. 9, Case1 is highly scored as evidence of Criterion1 and Case2 is moderate evidence of three criteria, providing three scores which may be weighted and combined for a total evidence score. Vendor2 has two more case studies, which are evidence of other criteria. Each document 102 is depicted with its associated evidence table 120 of feature words, which may be the basis of the match to criteria. Depending on the weighting and preferences implemented in the system, the Search Engine 150 may rank Vendor) highest for having the highest scoring evidence of any search criteria or may rank Vendor2 highest for having the evidence satisfying the most criteria and for having evidence satisfying all of the search criteria (even though across multiple documents). Thus the Search Engine may look only for documents satisfying all of the criteria. In exemplary embodiments, the Search Engine scores the document based on the sum of the weighted matches between features and all criteria within the one document. Only documents having evidence scores greater than a threshold are used towards the vendor score, in order to remove contributions from documents only satisfying few of the criteria. Equation 1 is an example algorithm for calculating a score for document j, using weights for each criteria i (repeated for all C criteria), where match( ) is a function that finds the feature in a document table 120 (or document 102) that best satisfies a criterion and returns a match value from zero to one.

doc_scoreⱼ=Σᵢ₌₁^{C}weightᵢ×match(doc_tablej,criteriaᵢ) Eq. 1

In a modification of the evidence-scoring algorithm, the search engine is arranged to highly score vendors having support for multiple criteria of the search query (in any number of documents). For example, it will more highly score vendors having case studies that support a location query and case studies that support a service query, than vendors having just many cases that support a location query, over and over again. This can be done by using a Diminishing Returns scoring algorithm, whereby the total score given to a vendor grows sublinearly with the number of documents that satisfy one criterion. The vendor score for vendorₖ may increase logarithmically with the number of documents that satisfy criteria1, plus logarithmically with the number of cases that satisfy criteria2, etc. In Eq. 2 below, the match function uses the evidence table 125, as a summary of all documents, but of course the match could be performed per document table 120 or per raw document 102.

vendorscoreₖ=Σᵢ₌₁^{C}weightᵢ×ln(match(evidence_tableₖ,criteriaᵢ)) Eq. 2

In addition to the evidence-based scoring and selection, vendors may be selected and scored based on the relevance of their attributes to the search query. For example, the user may search for vendors that must be in a country, further scored by the distance to a particular city.

### Display

The system receives queries and communicates results to users via a user interface on the user's computing device. The system prepares web content from the vendor and evidence data objects. A serialization agent serializes the web content in a format readable by the user's web browser and communicates said web content, over a network, to a client's or vendor's computing device.

The above description provides example methods and structures to achieve the invention and is not intended to limit the claims below. In most cases the various elements and embodiments may be combined or altered with equivalents to provide a recommendation method and system within the scope of the invention. It is contemplated that any part of any aspect or embodiment discussed in this specification can be implemented or combined with any part of any other aspect or embodiment discussed in this specification. Unless specified otherwise, the use of “OR” and “/” (the slash mark) between alternatives is to be understood in the inclusive sense, whereby either alternative or both alternatives are contemplated or claimed.

References in the above description to databases are not intended to be limiting to a particular structure or number of databases. The databases comprising case studies or business relationships may be implemented as a single database, separate databases, or a plurality of databases distributed across a network. The databases may be referenced separated above for clarity, referring to the type of data contained therein, even though it may be part of another database. One or more of the databases and agents may be managed by a third party in which case the overall system and methods or manipulating data are intended to include these third party databases and agents.

For the sake of convenience, the example embodiments above are described as various interconnected functional agents. This is not necessary, however, and there may be cases where these functional agents are equivalently aggregated into a single logic device, program or operation with unclear boundaries. In any event, the functional agents can be implemented by themselves, or in combination with other pieces of hardware or software.

While particular embodiments have been described in the foregoing, it is to be understood that other embodiments are possible and are intended to be included herein. It will be clear to any person skilled in the art that modifications of and adjustments to the foregoing embodiments, not shown, are possible.

Further explanation of some technique discussed above may be found in the following references:
Blei, D. M., Ng, A. Y., & Jordan, M. I. (2003). Latent dirichlet allocation. The Journal of Machine Learning Research, 3, pp. 993-1022.
Xu, Wei, Xin Liu, and Yihong Gong. “Document clustering based on non-negative matrix factorization.” Proceedings of the 26th annual international ACM SIGIR conference on Research and development in information retrieval. ACM, 2003.
Griffiths, D. M. B. T. L., and M. I. J. J. B. Tenenbaum. “Hierarchical topic models and the nested Chinese restaurant process.” Advances in neural information processing systems 16 (2004): 17.
Jagarlamudi, Jagadeesh, Hal Daumé III, and Raghavendra Udupa. “Incorporating lexical priors into topic models.” Proceedings of the 13th Conference of the European Chapter of the Association for Computational Linguistics. Association for Computational Linguistics, 2012.
Islam, Aminul, and Diana Inkpen. “Semantic text similarity using corpus-based word similarity and string similarity.” ACM Transactions on Knowledge Discovery from Data (TKDD) 2.2 (2008): 10.
Wallach, Hanna M. “Topic modeling: beyond bag-of-words.” Proceedings of the 23rd international conference on Machine learning. ACM, 2006.

1. A computer-implemented method of identifying vendors comprising:
providing a database comprising organization data objects and evidence documents, each evidence document associated with an organization data object and comprising text or tags describing real examples of services or products provided by a vendor identified in the associated organization data object;
receiving a search query from a user;
identifying, using one or more computing devices, from organization data objects in a database, vendors that satisfy the search query to create a set of matching vendors;
identifying, from the database, evidence documents associated with the matching vendors;
computing a vendor score for each matching vendor, based on a measure of relevance of their associated evidence documents to the search query;
selecting a subset of matching vendors to display to the user based on the vendor scores.

2. The method of claim 1, further comprising creating a document model of the evidence documents to extract a set of text features of evidence documents, and determining the measure of relevance using text features of the associated evidence documents.

3. The method of claim 1, wherein the one or more search criteria is directed to one or more attributes of a vendor, preferably one of which criteria is a capability of vendors, more preferably a service provided by vendors.

4. The method of claim 1, wherein identifying matching vendors and calculating vendor scores are based on the same criteria from the search query.

5. The method of claim 1, wherein the search query comprises criteria for identifying matching vendors and separate criteria for calculating vendor scores.

6. The method of claim 1, further comprising selecting and displaying one or more evidence documents with each associated vendor that is displayed.

7. The method of claim 1, further comprising identifying, for each vendor in the subset of matching vendors, one or more evidence documents having the highest measure of relevance and displaying those evidence documents.

8. The method of claim 1, wherein evidence documents comprise text describing capabilities in relation to provision of a service or product to a client from a vendor.

9. The method of claim 1, wherein evidence documents are one of more of: case studies, news articles, press release, or sample of work.

10. The method of claim 1, wherein the measure of relevance is computed by comparing the search query with text features extracted from the associated evidence documents using a document model.

11. The method of claim 1, further comprising computing vendor scores for each matching vendor based on the relevance of the vendor's attribute data to the search query.

12. The method of claim 1, wherein scoring vendor scores is at least partly determined by the number of evidence documents associated with each vendor that corroborate that vendor providing a service comprised in the search query.

13. A computer-implemented method comprising:
receiving, by one or more computing devices, an evidence document;
using a document model to performing feature extraction on the evidence documents to identify text features; and
storing, in a database, the text features as evidence of attribute values of a vendor, wherein at least one of the attribute values is a service provided by the vendor.

14. The method of claim 13, further comprising creating a vendor data object in a database of organizations and associating said object with the evidence document and/or extracted text features.

15. The method of claim 13, further comprising assigning one or more attribute types to extracted features.

16. The method of claim 13, wherein evidence documents comprise text describing capabilities in relation to provision of a service or product to a client from a vendor.

17. The method of claim 13, further comprising storing the text features as attribute values of the vendor in a vendor data object.

18. The method of claim 13, wherein storing comprises storing the text features in an evidence table attribute values of the vendor.

19. The method of claim 13, wherein the extracted text features comprise a) client identity or client industry and b) services or products previously provided, preferably further comprising one or more of: location data, methodology, result of the service or product, or client situation.

20. The method of claim 13, wherein the extracted text features are semantically related to capabilities of a vendor to provide products or services.

21. The method of claim 13, further comprising extracting from the evidence document an identity of an organization receiving services or products from the vendor, and creating a client data object, in the database, comprising the extracted identity.

22. The method of claim 21, further comprising creating a relationship data object linking the client data object and vendor data object.

23. The method of claim 13, wherein extracting features from documents comprises one of: named entity extraction, topic modeling, or vector space modeling.

24. The method of claim 22, further comprising determining attribute values from the evidence documents describing attributes of a relationship between the client and vendor and storing these attribute values with the relationship data object.

25. A computer-implemented method comprising:
receiving, by one or more computing devices, from a user, a search query for a service or product;
retrieving, by the one or more computing devices, from a database, evidence documents that describe provision of the product or service and
computing, by one or more computing devices an evidence score for each evidence document based on a measure of relevance of text features of the evidence documents to the search query; and
selecting and displaying, by the one or more computing devices, to the user, a subset of the evidence documents based on their evidence scores.

26. The method of claim 25, further comprising identifying, from the database, vendors associated with the evidence documents having the highest evidence scores and displaying to the user a subset of the vendors.

27. The method of claim 25, further comprising receiving, from the user, a selection of the displayed evidence documents and identifying, in the database, vendors associated with the selected evidence documents to display to the user.

28. The method of claim 25, wherein selecting and displaying evidence documents is based on determining, for each criterion in the search query, at least one evidence document that best satisfies that criterion.
